(19) United States
(12) Patent Application Publication
(10) Pub. No.: US 2005/0210661 A1
(43) Pub. Date: Sep. 29, 2005

(54) Universal harmonic balancer installation kit

(75) Inventors: Danny Williams, Clarinda, IA (US); Daniel K. Jasensky, Morriston, FL (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 10/806,831

(22) Filed: Mar. 23, 2004

(51) Int. Cl. F02B 75/06

(52) U.S. Cl. 29/700

(57) ABSTRACT

A universal harmonic balancer installation kit includes a collection of threaded rods and compatible threaded nuts correlated with each of the threaded rods and sized to position and engage a bushing against the hub of a harmonic balancer to thereby drive the balancer onto the end of a crankshaft. Various spacers and washers may be used in combination with the bushing and nuts to accommodate harmonic balancers of various size and configuration in combination with crankshafts having threaded installation openings of various sizes.

### BACKGROUND OF THE INVENTION

In a principal aspect, the present invention relates to a tool kit for installing harmonic balancers upon the end of the crankshaft of an internal combustion engine.

Typically, internal combustion engines incorporate a crankshaft with a harmonic balancer attached to one end of the crankshaft. Generally, a harmonic balancer comprises a cylindrical plate with a center hub having a hub opening to enable placement of the balancer over the end of a crankshaft. Heretofore, the application or installation of a harmonic balancer on the end of a crankshaft has been accomplished by engaging a threaded stud with an opening in the end of the crankshaft, placement of the harmonic balancer over the threaded stud and engagement of a nut with the harmonic balancer to drive the balancer onto the end of the crankshaft. Because the design of harmonic balancers and crankshafts vary from engine to engine, the utilization of a single installation tool to install harmonic balancers on multiple engines has not been possible. In an effort to overcome this problem, tool manufacturers developed kits which include an adapter designed to accommodate variously sized threaded openings in the end of a crankshaft having various thread pitches. Applicants' assignee has made and sold such a kit, Model No. 52200, “Harmonic Balancer Installer”, Lisle Corporation, Clarinda, Iowa. Apparatus of this general nature is also disclosed in expired U.S. Pat. No. 4,457,061 entitled “Harmonic Balancer Installer” issued Jul. 3, 1984, which is incorporated herewith by reference.

The use of such kits for the installation of harmonic balancers on the ends of various crankshafts has been successful. However, such kits are not universal. This results because of the numerous shapes and types of harmonic balancers available for internal combustion engines as well as the shape and configuration of the openings in the end of a crankshaft and the multiplicity of harmonic balance designs. Thus, there has developed a need for a universal harmonic balancer installation kit which will accommodate virtually all sizes and shapes of harmonic balancers as well as harmonic balancers having variously designs and crankshafts having various sized threaded openings to facilitate the installation of a harmonic balancer.

### BRIEF SUMMARY OF THE INVENTION

Briefly, the present invention comprises a harmonic balancer installation kit which includes a plurality of uniform diameter, threaded rods or studs with a polygonal drive at one end of each rod or stud. The kit further includes a bushing having a throughbore adapted to cooperate any one of a plurality of nuts. A separate nut is included for cooperation with each of the separate rods. Preferably, each of the nuts includes a cylindrical neck section which fits through the throughbore of the bushing so as to maintain alignment of the bushing and nut against the hub of a harmonic balancer that is being installed. Optional spacers and washers may be incorporated and positioned intermediate the drive nut and bushing to facilitate the universality of the installation kit.

In use, a stud or rod is chosen for threading into the end of a crankshaft. The choice of the stud or rod is based upon matching the thread size of the rod with the thread size of the opening in the end of the engine crankshaft. Next, a threaded nut compatible with and correlated to the thread size of the rod is threaded onto the rod. Then, a bushing and a harmonic balancer are placed over the rod adjacent the nut. The threaded nut preferably includes a cylindrical neck section which fits through the throughbore of the bushing so as to align the bushing properly on the rod and to also align the harmonic balancer. Additional spacer and/or washers may be inserted between the nut and the bushing to facilitate alignment and engagement of the bushing against the harmonic balancer. The rod is then threaded into the crankshaft opening. The nut is then tightened onto the rod to drive or push the harmonic balancer onto the end of the crankshaft of the internal combustion engine. The nut may then be removed from the rod. The polygonal end of the rod facilitates maintaining the rod in a fixed position when driving the nut onto or removing the nut from the rod. After removal of the nut from the rod, the remaining elements including the bushing, washer and spacers may be removed from the rod. The rod itself may then be removed from the end of the crankshaft by engaging the polygonal drive at the end of the rod and unthreading the rod from the threaded opening in the distal end of the crankshaft. A bolt is then threaded into the crankshaft to retain the harmonic balancer.

Thus, it is an object of the invention to provide an installation kit for harmonic balancers of the type used in combination with internal combustion engines.

Further, it is an object of the invention to provide an installation kit for harmonic balancers wherein the kit is comprised of a plurality of threaded rods, each rod capable of providing a connection to and to be threaded into the end of a crankshaft.

Another object of the invention is to provide a universal harmonic balancer installation kit which includes threaded rods, a bushing with a generally large throughbore, and drive nuts having a cylindrical section compatible with the bushing throughbore and further including compatible threads for engaging a correlated or compatible rod.

Another object of the invention is to provide a universal installation kit which is easy to use, economical, rugged and capable of utilization with substantially any and all harmonic balancer designs and engine crankshaft designs.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is a sectional view depicting the crankshaft and a first type of harmonic balancer;

FIG. 2 is a sectional view of an alternative design for a harmonic balancer and crankshaft;

FIG. 3 illustrates yet a further construction or design of a harmonic balancer;

FIG. 4 depicts another type of harmonic balancer and crankshaft combination;

FIG. 5 is a cross sectional view of typical elements incorporated in the harmonic balancer installation kit of the invention as combined for the installation of a particular type of harmonic balancer;

FIG. 6 is an exploded isometric view of the various elements includable in a harmonic balancer installation kit of the invention; and

FIGS. 7 through 18 are isometric views illustrating the sequential steps in the use of the tool kit of the invention.

### DETAILED DESCRIPTION OF THE INVENTION

FIGS. 1-4 are cross sectional views of various types of harmonic balancers that may be fitted onto a crankshaft by the tool kit of the invention. The balancers disclosed in FIGS. 1-4 are exemplary only and illustrate the problem addressed by the tool kit of the invention; namely, the problem of developing a means for attaching harmonic balancers of various size and construction using a tool kit comprised of the minimum number of elements or parts. Thus, referring to FIG. 1, there is depicted a harmonic balancer 10 which includes a generally cylindrical rim or plate 12 and a center hub 14 with a counterbore 16 designed to fit over the end 18 of a crankshaft 19. The harmonic balancer 10 is inserted onto the crankshaft 19 and retained thereon by a bolt 21. The harmonic balancer of FIG. 1 includes a bore 20 through which the bolt 21 may fit to engage a threaded opening 22 in the end of the crankshaft 19.

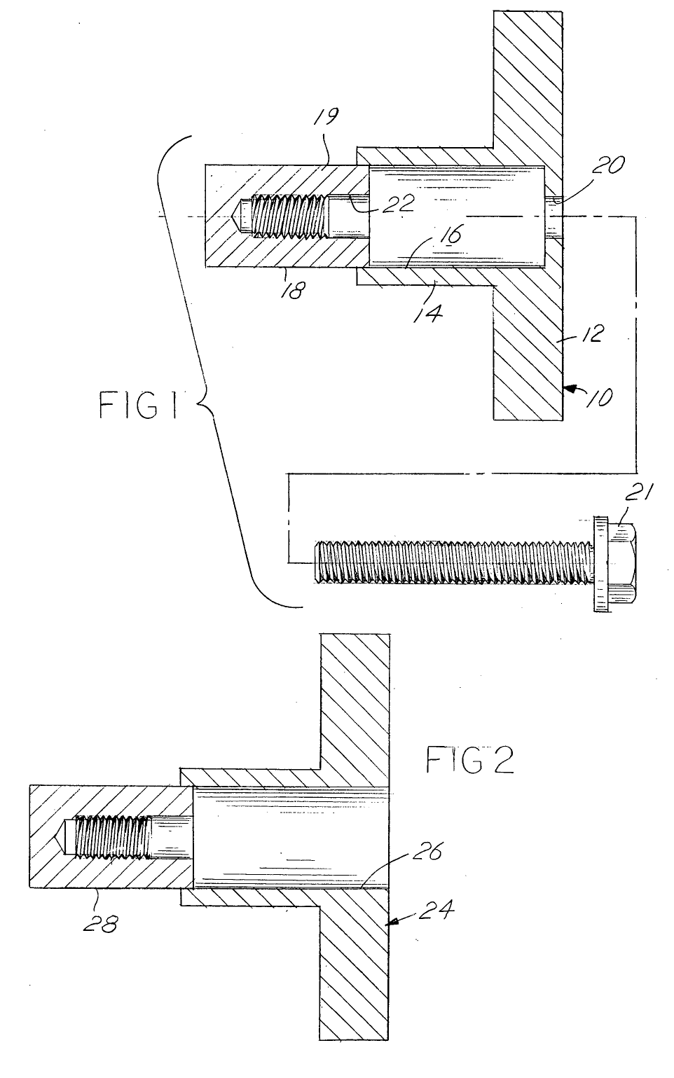

FIG. 2 illustrates yet another type of construction of a harmonic balancer. Here a balancer 24 includes a constant diameter bore 26 which fits over the end 18 of the crankshaft 28. Such a design is found, for example, in various General Motors vehicles including a 1991-1993 Oldsmobile Cutlass, Pontiac Grand Prix and Chevrolet Lumina.

FIG. 3 illustrates yet another type of harmonic balancer construction. A harmonic balancer 30 includes a shaped counterbore 32 which fits over the end of crankshaft 34. A bolt fits into the counterbore opening 36 associated with the bore 32. The harmonic balancer of the profile depicted in FIG. 3 can be found in the 1989-1995 Mercury Sable and Ford Taurus vehicles.

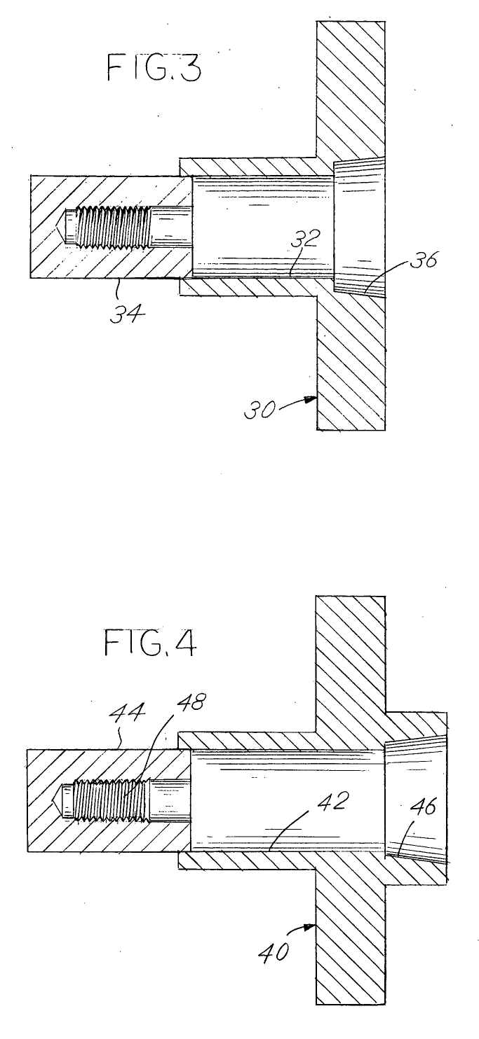

FIG. 4 illustrates yet a further harmonic balancer construction. A harmonic balancer 40 includes a bore 42 which fits over the end of the crankshaft 44. A bolt (not shown) fits through the bore 42 and the head of the bolt will fit into the counterbore section 46. A harmonic balancer of this type is found in the 1989-1995 Mercury Cougar and 1989-1995 Ford Thunderbird.

Various other types of harmonic balancer configurations, sizes and shapes are available and used in various types of internal combustion engines. Typically, the size of the threaded opening 48, for example, in FIG. 4 for each of the crankshafts, for example 44 in FIG. 4, associated with the harmonic balancer are generally of distinct bore sizes. Thus, the size of the threaded opening, e.g. 48 in FIG. 4, will vary from engine to engine. The diameter of the crankshaft will also vary from engine to engine. The shape, depth and dimensions of the bore, e.g. 42, 46 in FIG. 4, will vary from balancer to balancer. Thus, the installation of the harmonic balancer becomes a challenging matter for a mechanic repairing an internal combustion engine.

The present invention constitutes a kit which enables a mechanic to affix literally any harmonic balancer onto the end of any compatible crankshaft. FIG. 5 illustrates a typical configuration of elements utilized from such a kit. Referring to FIG. 5, a harmonic balancer 60 is applied to the end of a crankshaft 62 by utilizing a threaded rod shaft or stud 64 having a polygonal drive end 66. The threaded shaft 64 is sized to fit into the threaded opening 68 in the end of the crankshaft 62. It also fits through the center axial bore 70 in the hub of the harmonic balancer 60. The harmonic balancer 60 further includes a bore 72 which is received on the end of the crankshaft 62. The kit of the invention includes a thrust bearing or bushing 74 which is a generally annular member having an internal diameter throughbore 76 that is typically larger than the diameter of the threaded rod 64. A washer 78 may be fitted against the bushing 74 and a threaded thrust nut 80 having a polygonal head 82 and a cylindrical section 84 fits through a throughbore opening 86 in the washer 78 and is sized to also be received by the throughbore 76 of the thrust bearing or bushing 74. This facilitates alignment of the thrust bearing or bushing 74 as well as the washer 78. In the embodiment of FIG. 5, the use of a washer 78 is not necessary. However, the individual installing the harmonic balancer may desire to use such a washer 78 in the combination.

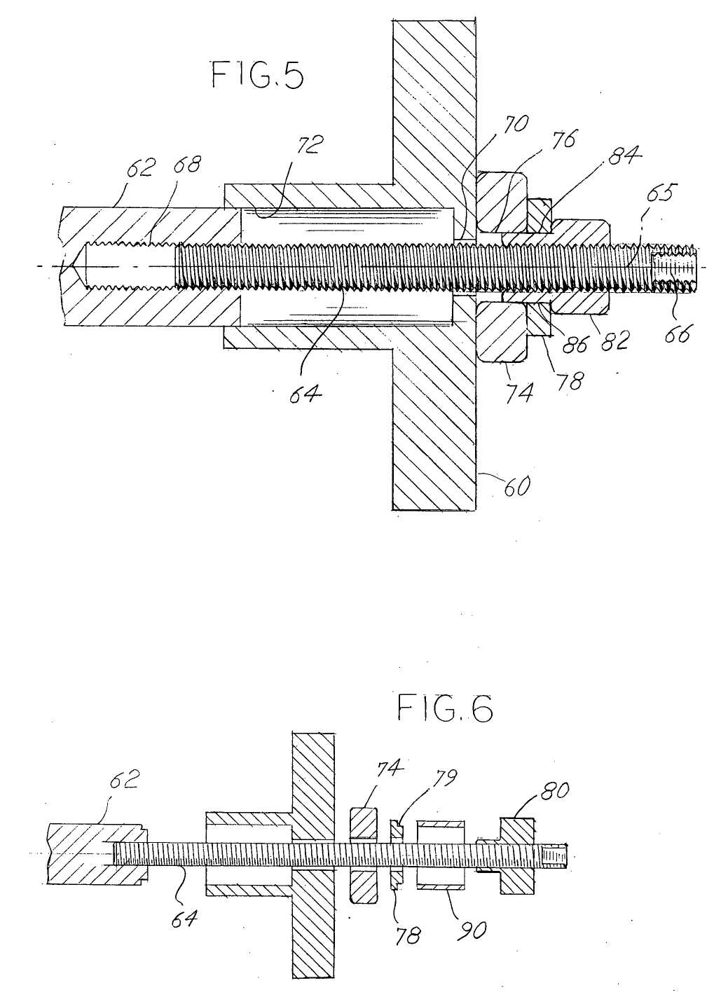

FIG. 6 illustrates additional elements which may be included in the installation kit. Thus, in addition to the thrust bearing or bushing 74 and washer 78, a spacer member in the form of a cylindrical tube 90 may be utilized. The threaded nut 80 will then fit against the spacer tube 90 or alternatively, an additional washer may be inserted between the threaded nut 80 and the spacer tube 90. In the embodiment depicted in FIG. 6, the washer 78 includes an annular recess 79 which cooperates with the spacer 90 to maintain alignment thereof along a center line axis 65 of the threaded shaft or rod 64.

Note that the threaded rod or shaft 64 is threaded substantially along the entire length but for the polygonal drive shaft section 66. As a consequence, the construction of the device is simplified inasmuch as the threads of the shaft 64 match the threads of bore 68 of the crankshaft 62 as well as the threads of the threaded nut 80.

In a preferred embodiment of the kit, following elements are included:

| | | |
|---|---|---|
| Thrust Bearing | ⅝-18 Nut | 9/16-18 Stud |
| 1⅝″ Washer | ¾-16 Nut | ⅝-11 Stud |
| 2⅛″ Tube | M10 × 1.5 Nut | ⅝-18 Stud |
| 2⅛″ Stepped Washer | M12 × 1.5 Nut | ¾-16 Stud |
| 1⅝″ Tube | M12 × 1.75 Nut | M10 × 1.5 Stud |
| 1⅝″ Stepped Washer | M14 × 1.5 Nut | M12 × 1.5 Stud |
| 1 43/64 Spacer | M14 × 2.0 Nut | M12 × 1.75 Stud |
| 2 1/16″ Spacer | M16 × 1.5 Nut | M14 × 1.5 Stud |
| 7/16-20 Nut | M16 × 2.0 Nut | M14 × 2.0 Stud |
| ½-20 Nut | M18 × 1.5 Nut | M16 × 1.5 Stud |
| 9/16-18 Nut | 7/16-20 Stud | M16 × 2.0 Stud |
| ⅝-11 Nut | ½-20 Stud | M18 × 1.5 Stud |

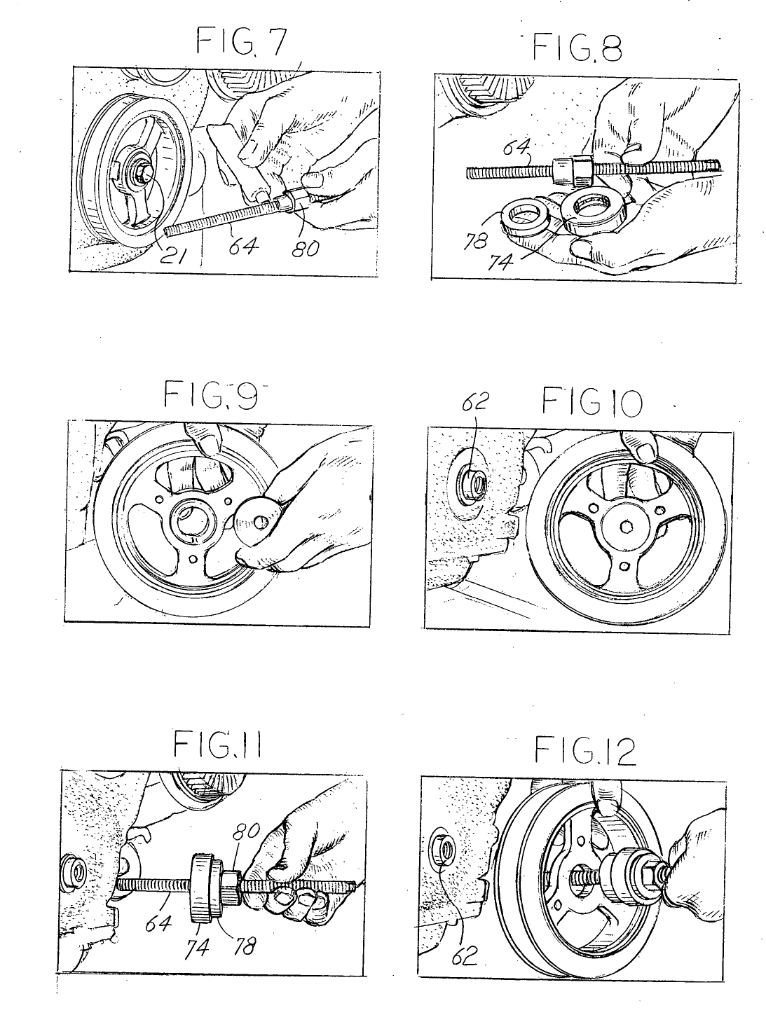

FIGS. 7-18 depict the method of use of the elements of the kit of the invention. Referring first to FIG. 7, the mechanic will choose an appropriate rod or stud and apply grease to the threads to prevent seizing. Next, a nut is hand threaded onto the rod from the threaded end of the rod rather than the end with the drive 66.

Next, referring to FIG. 8, a washer or combination or stepped washers, spacers and the thrust bearing or bushing are chosen by the mechanic based upon the balancer. The elements are then placed on the rod.

Referring to FIG. 9, if necessary, a spacer may be used to fit against the inside rim of the bore through the harmonic balancer to provide for proper access and spacing of the nut 80 from the hub of the harmonic balancer.

As shown in FIG. 10, it is necessary to check the manner in which the various component parts are fitted with respect to the harmonic balancer to insure that access is maintained with respect to the nut 80 so that the nut 80 may be turned to push the harmonic balancer onto the end of the crankshaft.

As depicted in FIG. 11, the washer or washers, bushing and so on are all placed upon the rod or shaft with the flats or drive portion of the rod positioned away from the crankshaft. Next, as depicted in FIG. 12, the spacer on the front of the assembly is placed over the rod or shaft and then the harmonic balancer is placed over the rod or shaft.

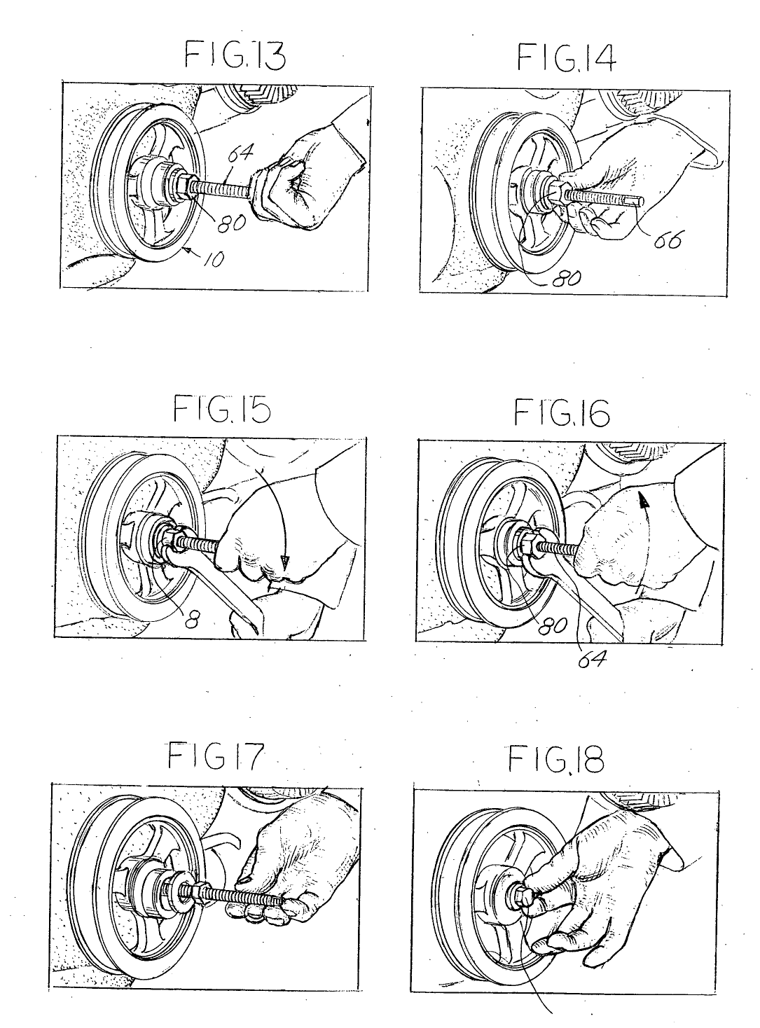

As shown in FIG. 13, the rod is then hand-tightened into the bolt hole of the end of the crankshaft until it bottoms out. The nut 80 is then tightened by hand as depicted in FIG. 14 to move the harmonic balancer into position on the end of the crankshaft. As depicted in FIG. 15, the nut is tightened by a wrench until the harmonic balancer is in place on the crankshaft.

As shown in FIG. 16, the next step is to remove the tool by loosening of the nut 80 and then loosening and removal of the stud, rod or shaft 64 as depicted in FIG. 17. A wrench may be used if necessary.

As depicted in FIG. 18, the final step is to insert the bolt 100 which is used to maintain the harmonic balancer connected to the crankshaft.

There has been set forth a preferred embodiment of the invention. However, the kit of the invention may be modified, for example, by using spacers of various sizes and dimension without departing from the spirit and scope of the invention. The invention is therefore to be limited only by the following claims and equivalents thereof.

1. A universal harmonic balancer installation kit comprising, in combination:
(a) a plurality of generally uniform diameter threaded, elongate rods, each rod including a longitudinal axis, an outer end polygonal drive, and a unique thread diameter rand pitch;
(b) a universal bushing having a throughbore with a diameter greater than the maximum thread diameter of a plurality of the elongate rods; and
(c) a plurality of threaded drive nuts, each of said nuts with a thread size and diameter correlated to one of said rods, at least some of said nuts including a cylindrical neck section sized to fit into the bushing throughbore and a polygonal drive section for cooperation with a drive tool, whereby the threaded rod may be threaded into a compatible threaded opening in the end of a crankshaft, and a harmonic balancer placed over the rod with a bushing engaged against the balancer and a nut threaded onto the rod positioned against the bushing as the rod is held in position to thereby drive and install the balancer on the crankshaft.

2. The kit of claim 1 including at least one washer sized to fit between a nut and said bushing on a rod.

3. The kit of claim 1 including at least one spacer sized to fit between a nut and said bushing on a rod.

4. The kit of claim 1 including at least one washer and spacer in combination to fit between a nut and said bushing on a rod.

5. The kit of claim 1 including the following component parts:

| | | |
|---|---|---|
| Thrust Bearing | ⅝-18 Nut | 9/16-18 Stud |
| 1⅝″ Washer | ¾-16 Nut | ⅝-11 Stud |
| 2⅛″ Tube | M10 × 1.5 Nut | ⅝-18 Stud |
| 2⅛″ Stepped Washer | M12 × 1.5 Nut | ¾-16 Stud |
| 1⅝″ Tube | M12 × 1.75 Nut | M10 × 1.5 Stud |
| 1⅝″ Stepped Washer | M14 × 1.5 Nut | M12 × 1.5 Stud |
| 1 43/64 Spacer | M14 × 2.0 Nut | M12 × 1.75 Stud |
| 2 1/16″ Spacer | M16 × 1.5 Nut | M14 × 1.5 Stud |
| 7/16-20 Nut | M16 × 2.0 Nut | M14 × 2.0 Stud |
| ½-20 Nut | M18 × 1.5 Nut | M16 × 1.5 Stud |
| 9/16-18 Nut | 7/16-20 Stud | M16 × 2.0 Stud |
| ⅝-11 Nut | ½-20 Stud | M18 × 1.5 Stud |
